(19) United States
(12) Patent Application Publication
(10) Pub. No.: US 2017/0180232 A1
(43) Pub. Date: Jun. 22, 2017

(54) APPARATUS AND METHOD FOR SETTING BANDWIDTH

(71) Applicant: FUJITSU LIMITED, Kawasaki-shi (JP)

(72) Inventors: Takayuki Nakamura, Kawasaki (JP); ATSUSHI NAGASE, Kawasaki (JP); KENICHI TAKAYANAGI, Kawasaki (JP); Ryoshin YANAGIDA, Kanazawa (JP); Miho Inagaki, Toyama (JP)

(73) Assignee: FUJITSU LIMITED, Kawasaki-shi (JP)

(21) Appl. No.: 15/380,362

(22) Filed: Dec. 15, 2016

(30) Foreign Application Priority Data
Dec. 16, 2015 (JP) 2015-244975

(51) Int. Cl. H04L 12/26; H04L 12/861; G06F 9/455

(52) U.S. Cl. CPC H04L 43/0876; G06F 9/45558; H04L 49/9068; G06F 2009/45595

(57) ABSTRACT

A disclosed bandwidth setting method includes: calculating, for each of plural logical ports that are set for a physical network interface card, an amount of traffic of the logical ports, from amounts of output traffic of one or plural virtual machines that use the logical port; and setting, for each of the plural logical ports, bandwidth of the logical port according to the calculated amount of traffic of the logical port.

### CROSS-REFERENCE TO RELATED APPLICATIONS

This application is based upon and claims the benefit of priority of the prior Japanese Patent Application No. 2015-244975, filed on Dec. 16, 2015, the entire contents of which are incorporated herein by reference.

### FIELD

This invention relates to a technique for setting bandwidth.

### BACKGROUND

There is a technique for logically dividing a physical NIC (Network Interface Card) and handling that physical NIC as plural logical ports. By using this technique, it is possible to divide, for example, one physical port into four logical ports, and a virtual machine is able to perform communication using a logical port in the same way as a physical port.

Part of bandwidth of a physical port is assigned to each logical port. However, when the bandwidth of each logical port is fixedly set, it is impossible to follow sudden increases in an amount of traffic, and a bottleneck occurs in the network. For example, when a virtual machine is newly added, or an amount of traffic increases due to a specific application on a virtual machine, bandwidth that is available to virtual machines that use the same logical port is limited. On the other hand, when a virtual machine migrates due to migration or the like, or when use of an application ends, bandwidth that was assigned for logical ports is not used and may be in excess.

In regard to this point, a certain document discloses a technique for switching a physical NIC of a connection destination of a virtual NIC based on priority of a virtual machine. Moreover, another document discloses a technique for controlling the transmission order of packets based on priority information or the like that is included in packets that are transmitted from a virtual machine. However, in these conventional techniques, bandwidth that is assigned to logical ports is not controlled. And part of the bandwidth of a physical NIC is not used, and a state of excess may occur.

Patent Document 1: Japanese Laid-open Patent Publication No. 2009-176103

Patent Document 2: Japanese Laid-open Patent Publication No. 2009-239374

In other words, there is no technique to increase utilization efficiency of bandwidth of a physical NIC for which plural logical ports are set.

### SUMMARY

A bandwidth setting method relating to this invention includes: calculating, for each of plural logical ports that are set for a physical network interface card, an amount of traffic of the logical ports, from amounts of output traffic of one or plural virtual machines that use the logical port; and setting, for each of the plural logical ports, bandwidth of the logical port according to the calculated amount of traffic of the logical port.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an outline of a system in a first embodiment;

FIG. 2 is a diagram depicting a functional block diagram of a management server;

FIG. 3 is a configuration diagram of an operation server in the first embodiment;

FIG. 4 is a diagram to explain dividing of a physical port;

FIG. 5 is a diagram depicting an example of data stored in a data storage unit;

FIG. 6 is a diagram depicting a processing flow of processing executed by an I/O (Input/Output) traffic controller;

FIG. 7 is a diagram depicting a processing flow of processing executed by a NIC data management unit;

FIG. 8 is a diagram depicting a processing flow of processing executed by a traffic controller;

FIG. 9 is a diagram depicting a processing flow of processing of executed by a HV data management unit;

FIG. 10 is a diagram to explain calculation of an amount of traffic of a logical port;

FIG. 11 is a diagram to explain setting for bandwidth;

FIG. 12 is a diagram depicting a processing flow of processing executed by a bandwidth management unit;

FIG. 13 is a diagram to explain sequential processing from initial setting for bandwidth to change of setting;

FIG. 14 is a configuration diagram of the operation server in a second embodiment;

FIG. 15 is a functional block diagram of a computer; and

FIG. 16 is a hardware configuration diagram of the operation server.

### DESCRIPTION OF EMBODIMENTS

### Embodiment 1

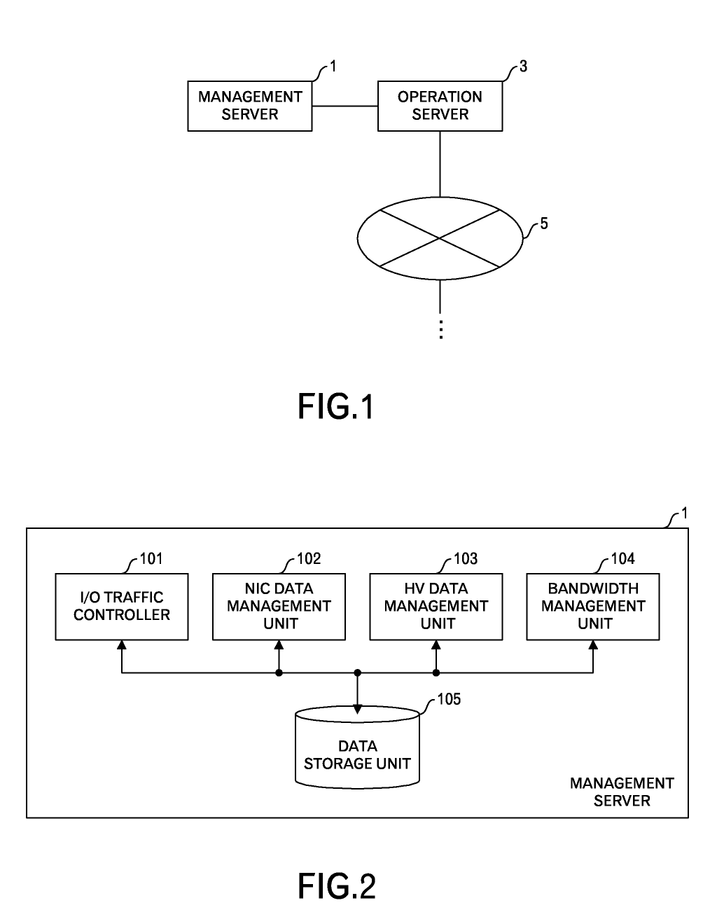

FIG. 1 illustrates an overview of a system in a first embodiment. A management server 1 that executes main processing of this embodiment is connected to an operation server 3 that is managed. The operation server 3 is connected to a network 5, which is, for example, a network of a data center. Other operation servers are also connected to the network 5, however, such connections are not directly related to the explanation of this embodiment, and an explanation thereof is omitted.

FIG. 2 illustrates a functional block diagram of the management server 1. The management server 1 includes an I/O traffic controller 101, an NIC data management unit 102, an HV (HyperVisor) data management unit 103, a bandwidth management unit 104 and a data storage unit 105.

The I/O traffic controller 101 executes processing to calculate bandwidth that is set for each logical port based on data that is stored in the data storage unit 105. The NIC data management unit 102 obtains, according to an acquisition instruction from the I/O traffic controller 101, data from a physical NIC of the operation server 3, and stores that data in the data storage unit 105. The HV data management unit 103 obtains, according to an acquisition instruction from the I/O traffic controller 101, data from the hypervisor (also called virtualization software) that operates on the operation server 3, and stores that data in the data storage unit 105. The bandwidth management unit 104 executes, according to an instruction from the I/O traffic controller 101, processing to set bandwidth for each logical port.

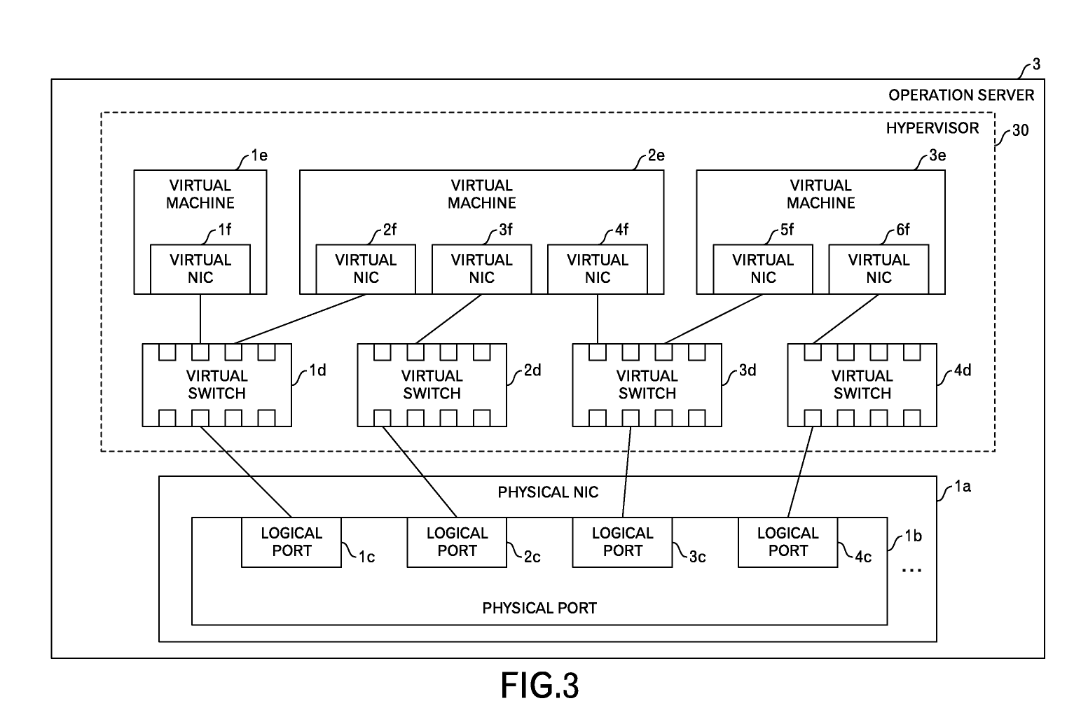

FIG. 3 illustrates a configuration diagram of the operation server 3. The operation server 3 has a physical NIC 1a which is hardware, and the physical port 1b of the physical NIC 1a is logically divided into logical ports 1c to 4c. In FIG. 3, the number of physical NICs is 1 and the number of logical ports is 4, however, these numbers are not limited.

In the operation server 3, a hypervisor 30 is executed, and virtual switches 1d to 4d and virtual machines 1e to 3e operate on the hypervisor 30. The virtual machine 1e includes a virtual NIC 1f, and the virtual NIC 1f is connected to the virtual switch 1d. The virtual machine 2e includes virtual NICs 2f to 4f, and the virtual NIC 2f is connected to the virtual switch 1d, the virtual NIC 3f is connected to the virtual switch 2d, and the virtual NIC 4f is connected to the virtual switch 3d. The virtual machine 3e includes virtual NICs 5f and 6f, and the virtual NIC 5f is connected to the virtual switch 3d, and the virtual NIC 6f is connected to the virtual switch 4d. The virtual switch 1d is connected to the logical port 1c, the virtual switch 2d is connected to the logical port 2c, the virtual switch 3d is connected to the logical port 3c, and the virtual switch 4d is connected to the logical port 4c.

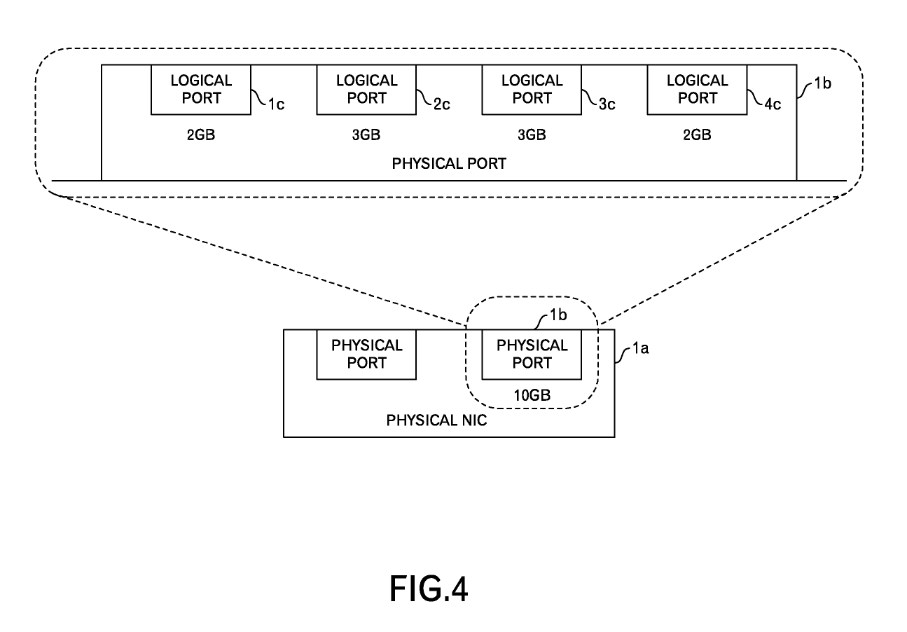

Logical ports are set for each physical port, and as illustrated in FIG. 4, for example, when the number of physical ports is 2 and the number of logical ports is 4, the physical NIC 1a has eight logical ports. Moreover, in this embodiment, initially, bandwidth is set for each logical port by an administrator, and after that, the bandwidth for each logical port changes dynamically according to the actual operating conditions. For example, in a case in which the bandwidth for a physical port is 10 gigabits (GB) per sec (hereafter, “per sec” will be omitted in order to simplify the explanation), bandwidth are set for each of the logical ports so that the total bandwidth becomes 10 GB.

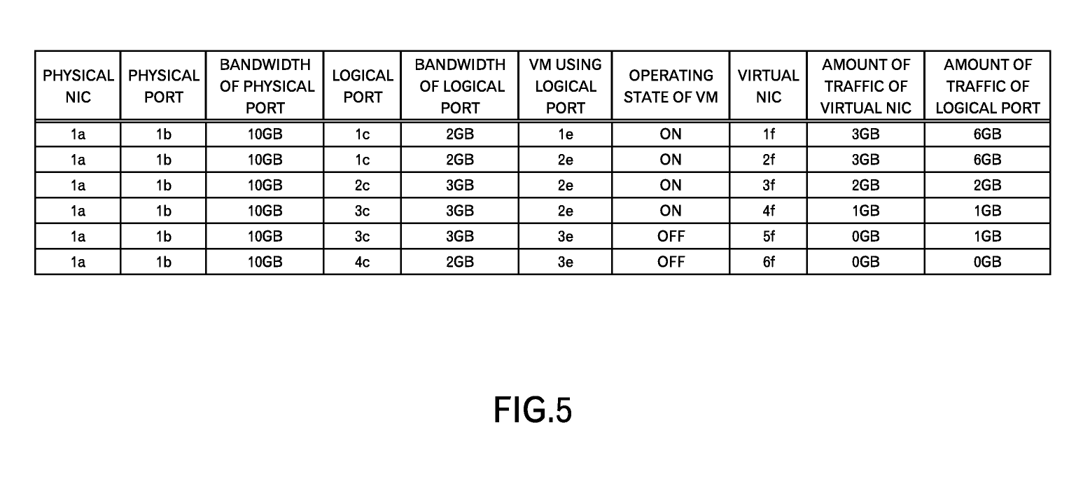

FIG. 5 illustrates an example of data that is stored in the data storage unit 105. In the example in FIG. 5, an identifier of a physical NIC, an identifier of a physical port, bandwidth of the physical port, an identifier for a logical port, bandwidth of the logical port, an identifier of a virtual machine that uses the logical port, information that represents an operating state of the virtual machine, an identifier of a virtual NIC, an amount of traffic of the virtual NIC (similarly to bandwidth, the unit is bits per sec), and an amount of traffic of the logical port are stored. The identifier of the physical NIC, the identifier of the physical port, the identifier for the logical port, and the bandwidth of the physical port are stored by the NIC data management unit 102. The identifier of the virtual machine that uses the logical port, the information that represents the operating state of the virtual machine, the identifier of the virtual NIC, and the amount of traffic of the virtual NIC are stored by the HV data management unit 103. The bandwidth of the logical port and the amount of traffic of the logical port are stored by the I/O traffic controller 101. The amount of traffic of the virtual NIC is the amount of output traffic from the virtual NIC, and the amount of traffic of the logical port is the amount of output traffic from the logical port. Moreover, traffic is I/O traffic.

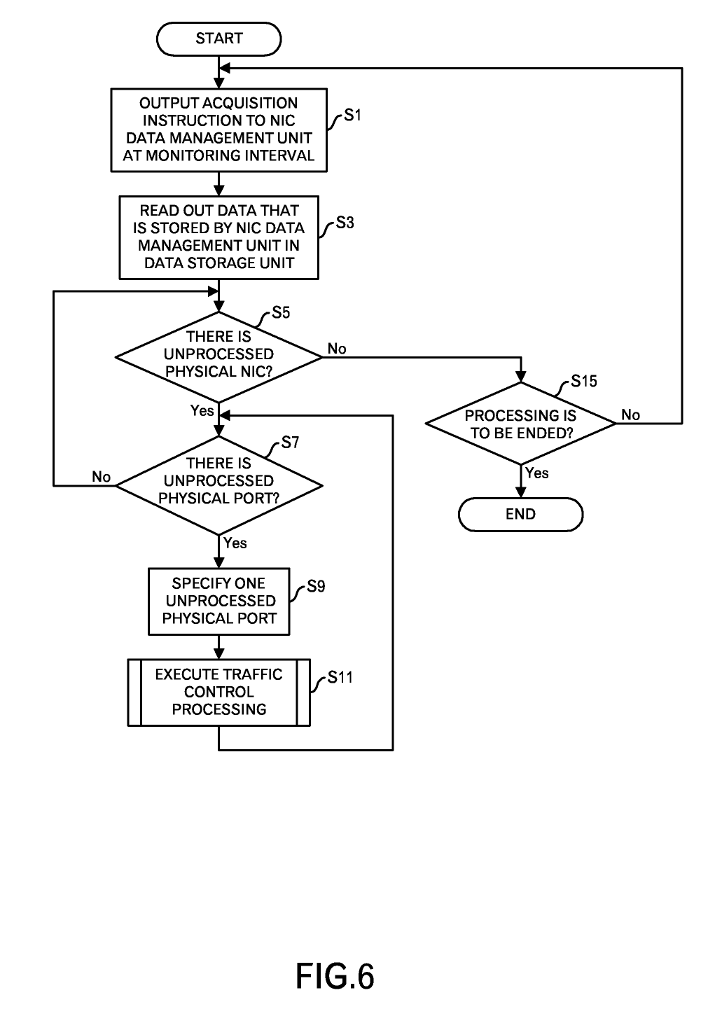

Next, operation of the management server 1 will be explained using FIG. 6 to FIG. 13.

First, processing that the I/O traffic controller 101 executes will be explained. The I/O traffic controller 101 outputs an acquisition instruction to the NIC data management unit 102 at preset monitoring interval (FIG. 6: step S1). After the monitoring interval has elapsed since the previous processing of step S1 was executed, the processing of step S1 is executed, and when the monitoring interval has not yet elapsed since the previous processing of step S1 was executed, the I/O traffic controller 101 waits until the monitoring interval elapses.

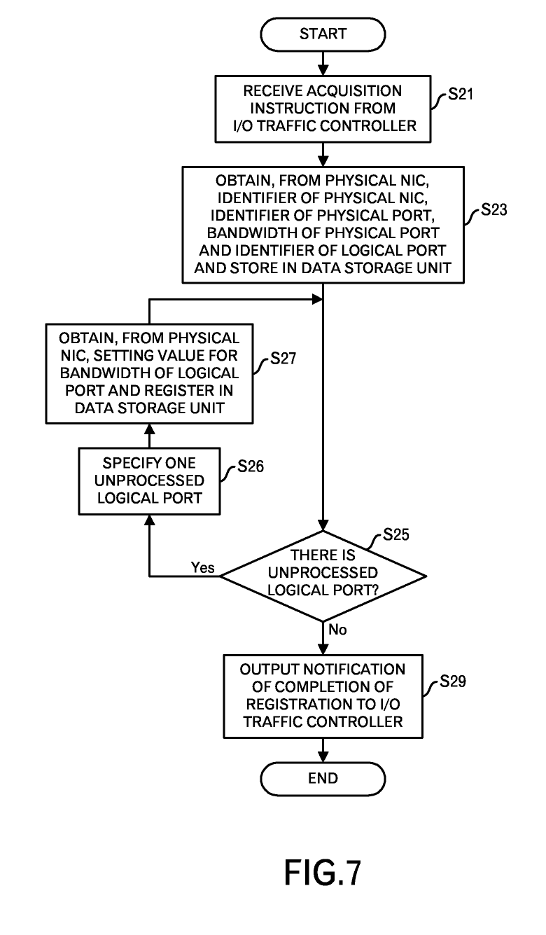

Here, processing that is executed by the NIC data management unit 102 that received the acquisition instruction from the I/O traffic controller 101 will be explained using FIG. 7.

First, the NIC data management unit 102 receives an acquisition instruction from the I/O traffic controller 101 (FIG. 7: step S21).

The NIC data management unit 102 obtains an identifier of a physical NIC, identifiers of physical ports, bandwidth of the physical ports, and identifiers of logical ports in the operation server 3 from the physical NIC 1a. Then, the NIC data management unit 102 stores the obtained identifiers of the physical NICs, the identifiers of the physical ports, the bandwidth of the physical ports, and the identifiers of the logical ports in the data storage unit 105 (step S23). Normally, tools and the like that are employed by the operation server 3 to manage the physical NIC 1a manage this kind of information. Therefore, the NIC data management unit 102 obtains information by sending a request to the tools and the like.

The NIC data management unit 102 determines whether there is an unprocessed logical port among the logical ports that are specified by the identifiers of the logical ports obtained in step S23 (step S25). When there is an unprocessed logical port (step S25: YES route), the NIC data management unit 102 specifies one unprocessed logical port (step S26).

The NIC data management unit 102 obtains a setting value for bandwidth of the unprocessed logical port that was specified in step S26 from the physical NIC 1a. Then, the NIC data management unit 102 stores the obtained setting value for bandwidth in the data storage unit 105 (step S27). The processing then returns to step S25.

On the other hand, when there is not an unprocessed logical port (step S25: NO route), the NIC data management unit 102 outputs a notification of completion of registration to the I/O traffic controller 101 (step S29). The processing then ends.

Returning to the explanation of FIG. 6, after receiving the notification of completion of registration from the NIC data management unit 102, the I/O traffic controller 101 reads out data that was stored in the data storage unit 105 by the NIC data management unit 102 (step S3).

The I/O traffic controller 101 determines whether there is an unprocessed physical NIC among physical NICs that were specified by identifiers of the physical NICs, which were included in the data that was read out in step S3 (step S5).

When there is an unprocessed physical NIC (step S5: YES route), the I/O traffic controller 101 specifies one unprocessed physical NIC. The I/O traffic controller 101 then determines whether there is an unprocessed physical port among the physical ports of the specified physical NIC (step S7). When there is an unprocessed physical port (step S7: YES route), the I/O traffic controller 101 specifies one unprocessed physical port (step S9).

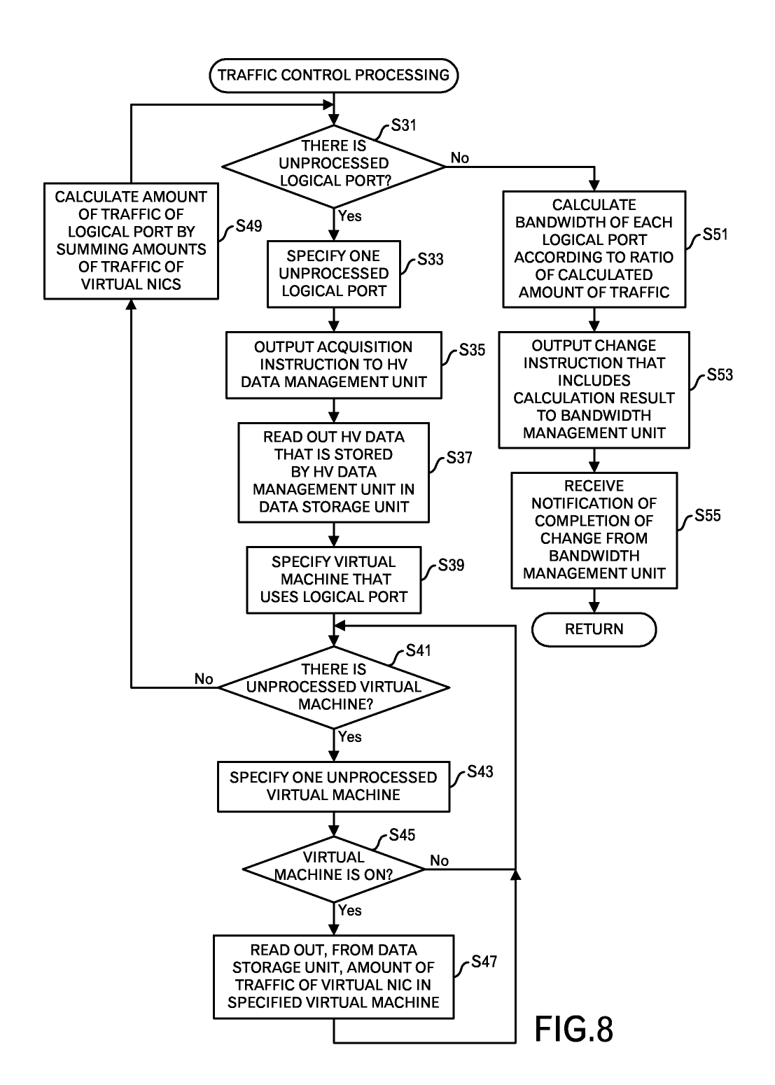

The I/O traffic controller 101 executes traffic control processing (step S11). The processing then returns to step S7. The traffic control processing will be explained using FIG. 8 to FIG. 12.

First, the I/O traffic controller 101 determines whether there is an unprocessed logical port among the logical ports that were set for the physical port that was specified in step S9 (FIG. 8: step S31). When there is an unprocessed logical port (step S31: YES route), the I/O traffic controller 101 specifies one unprocessed logical port (step S33).

The I/O traffic controller 101 generates an acquisition instruction that includes the identifier of the logical port that was specified in step S33, and outputs that acquisition instruction to the HV data management unit 103 (step S35).

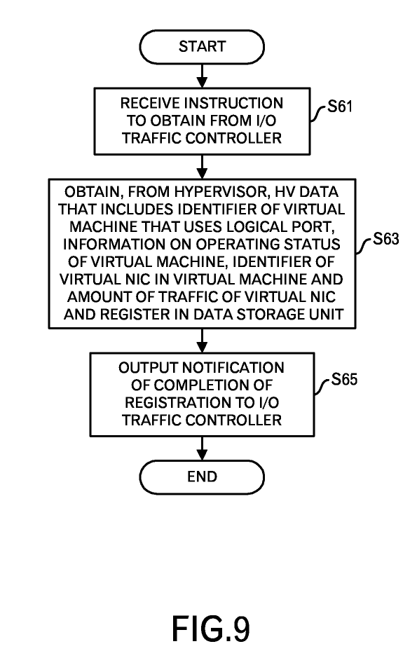

Here, the processing that is executed by the HV data management unit 103 that received the acquisition instruction from the I/O traffic controller 101 will be explained using FIG. 9.

First, the HV data management unit 103 receives the acquisition instruction from the I/O traffic controller 101 (FIG. 9: step S61). The acquisition instruction includes the identifier of the logical port that was specified in step S33, and the HV data management unit 103 executes processing for that logical port.

The HV data management unit 103 obtains HV data that includes identifiers of virtual machines that use the logical port, information that represents operating states of the virtual machines, identifiers of the virtual NICs in the virtual machines, and amounts of traffic of the virtual NICs (for example, average amounts of traffic during the most recent fixed period) from the hypervisor 30. The HV data management unit 103 then stores the obtained HV data in the data storage unit 105 (step S63). Normally, the hypervisor 30 manages this kind of HV data. Therefore, the HV data management unit 103 obtains HV data by sending a request to the hypervisor 30.

The HV data management unit 103 outputs a notification of completion of registration to the I/O traffic controller 101 (step S65). The processing then ends.

Returning to the explanation of FIG. 8, after receiving the notification of completion of registration from the HV data management unit 103, the I/O traffic controller 101 reads out the HV data that was stored in the data storage unit 105 by the HV data management unit 103 (step S37).

The I/O traffic controller 101 specifies virtual machines that use the logical port that was specified in step S33 from the HV data that was read out in step S37 (step S39).

The I/O traffic controller 101 determines whether there is an unprocessed virtual machine among the virtual machines specified in step S39 (step S41). When there is an unprocessed virtual machine (step S41: YES route), the I/O traffic controller 101 specifies one unprocessed virtual machine (step S43).

The I/O traffic controller 101 determines whether an operating state of the virtual machine that was specified in step S43 is “ON” (step S45). The “ON” state is a state in which the virtual machine is operating, and “OFF” state is a state in which the virtual machine is not operating.

When the operating state of the virtual machine is not “ON” (step S45: NO route), the processing returns to step S41. On the other hand, when the operating state of the virtual machine is “ON” (step S45: YES route), the I/O traffic controller 101 reads out an amount of traffic of a virtual NIC in the virtual machine that was specified in step S43 from the data storage unit 105 (step S47). The processing then returns to step S41.

On the other hand, when there is no unprocessed virtual machine (step S41: NO route), the I/O traffic controller 101 calculates an amount of traffic of the logical port that was specified in step S33 by summing amounts of traffic of the virtual NICs in the virtual machines that were specified in step S39 (step S49), and stores the result in the data storage unit 105. The processing then returns to step S31.

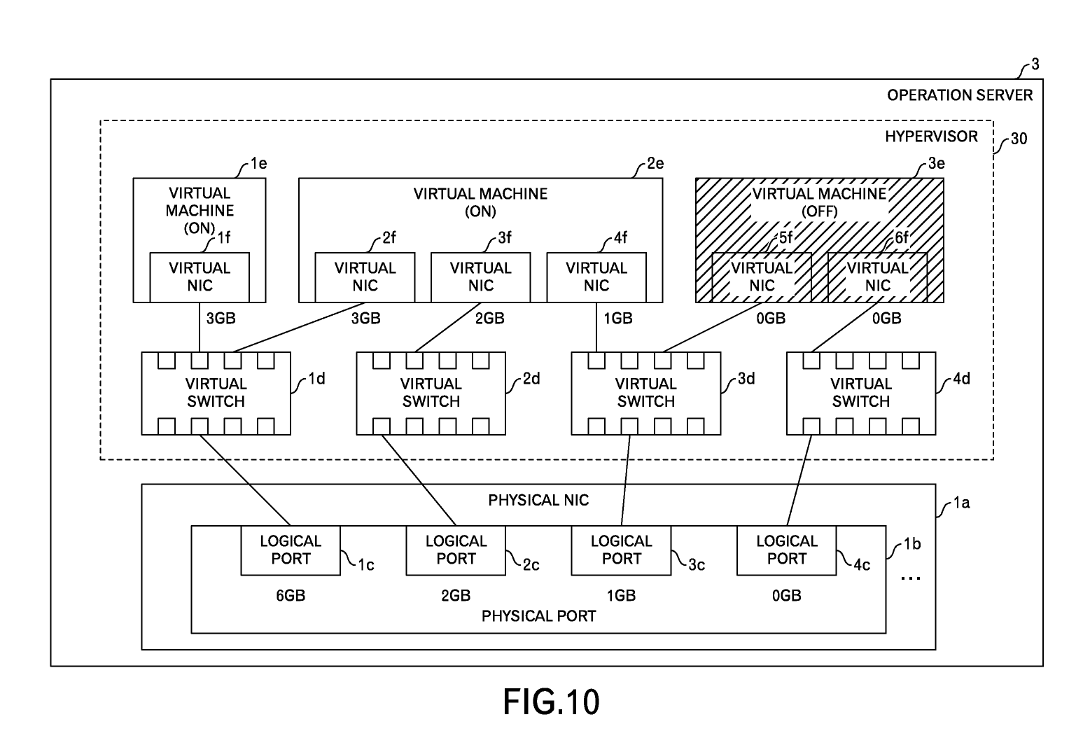

For example, calculating an amount of traffic of a logical port that is in a state such as illustrated in FIG. 10 will be considered. In the example in FIG. 10, operating states of the virtual machines 1e and 2e is “ON”, and an operating state of the virtual machine 3e is “OFF”. The amount of traffic of the virtual NIC 1f is 3 GB, the amount of traffic of the virtual NIC 2f is 3 GB, the amount of traffic of the virtual NIC 3f is 2 GB, the amount of traffic of the virtual NIC 4f is 1 GB, the amount of traffic of the virtual NIC 5f is 0 GB, and the amount of traffic of the virtual NIC 6f is 0 GB.

In this case, the amount of traffic of the logical port 1c is 3+3=6 GB, the amount of traffic of logical port 2c is 2 GB, the amount of traffic of logical port 3c is 1 GB and the amount of traffic of logical port 4c is 0 GB.

Returning to the explanation of FIG. 8, when there is no unprocessed logical port (step S31: NO route), the I/O traffic controller 101 calculates bandwidth for each logical port according to ratios of the amounts of traffic, which were calculated in step S49 (step S51). The I/O traffic controller 101 stores the bandwidth of each of the logical ports that were calculated in step S51 in the data storage unit 105.

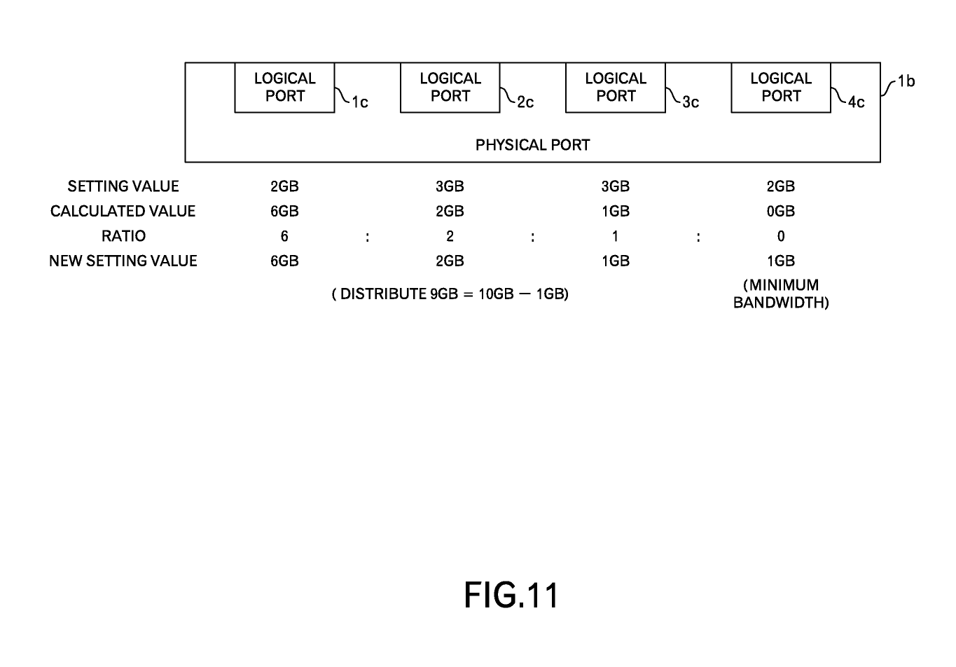

As illustrated in FIG. 11, for example, assume that the setting value of the logical port 1c is 2 GB, the setting value for the logical port 2c is 3 GB, the setting value of the logical port 3c is 3 GB, and the setting value of the logical port 4c is 2 GB. Then, assume that the amount of traffic of the logical port 1c that was calculated in step S49 is 6 GB, the amount of traffic of the logical port 2c is 2 GB, the amount of traffic of the logical port 3c is 1 GB, and the amount of traffic of the logical port 4c is 0 GB.

In this case, the ratios of the amounts of traffic of the logical ports are 6:2:1:0. Here, the amount of traffic of the logical port 4c is 0, however, in consideration of a possibility of traffic occurring in the future, a preset minimum bandwidth is set for the logical port 4c. In the casein FIG. 11, the minimum bandwidth is 1 GB. The remaining 9 (=10−1) GB are assigned to the logical ports 1c to 3c according to the ratios (6:2:1). Here, the new setting value for the logical port 1c is 6 GB, the new setting value for the logical port 2c is 2 GB, and the new setting value for the logical port 3c is 1 GB. However, the minimum bandwidth is not limited to 1 GB. For example, when the minimum bandwidth is 100 MB, the bandwidth (10 GB-100 MB) is distributed to the logical ports 1c to 3c according to the ratios.

Returning to the explanation of FIG. 8, the I/O traffic controller 101 outputs a change instruction that includes the results of the calculation in step S51 (in other words, the new setting value for each of the logical ports) to the bandwidth management unit 104 (step S53).

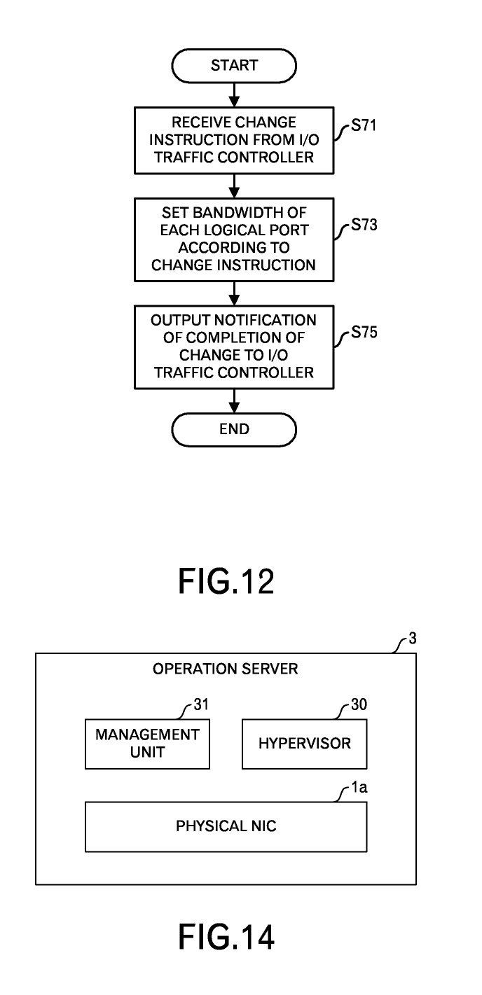

Here, the processing that is executed by the bandwidth management unit 104 that received the change instruction from the I/O traffic controller 101 will be explained using FIG. 12.

First, the bandwidth management unit 104 receives a change instruction from the I/O traffic controller 101 (FIG. 12: step S71). The change instruction includes the bandwidth of each of logical ports, which were calculated in step S51.

The bandwidth management unit 104 sets the bandwidth for each logical port according to the change instruction that was received in step S71 (step S73). Normally, by using tools and the like that are employed by the operation server 3 in order to manage the physical NIC 1a, it is possible to write the setting values in the memory area of the physical port 1b. Therefore, the new setting values are set by the NIC data management unit 102 sending a request to those tools and the like.

The bandwidth management unit 104 outputs a change complete notification to the I/O traffic controller 101 (step S75). Processing then ends.

Returning to the explanation of FIG. 8, the I/O traffic controller 101 receives a notification of completion of change from the bandwidth management unit 104 (step S55). The processing returns to the calling source.

Returning to the explanation of FIG. 6, when there is not an unprocessed physical port (step S7: NO route), the processing returns to step S5. Then, when there is no unprocessed physical NIC (step S5: NO route), the I/O traffic controller 101 determines whether the processing is to be ended (for example, whether an instruction to end processing is received from the administrator) (step S15). When the processing is not to be ended (step S15: NO route), the processing returns to step S1. On the other hand, when the processing is to be ended (step S15: YES route), the processing ends.

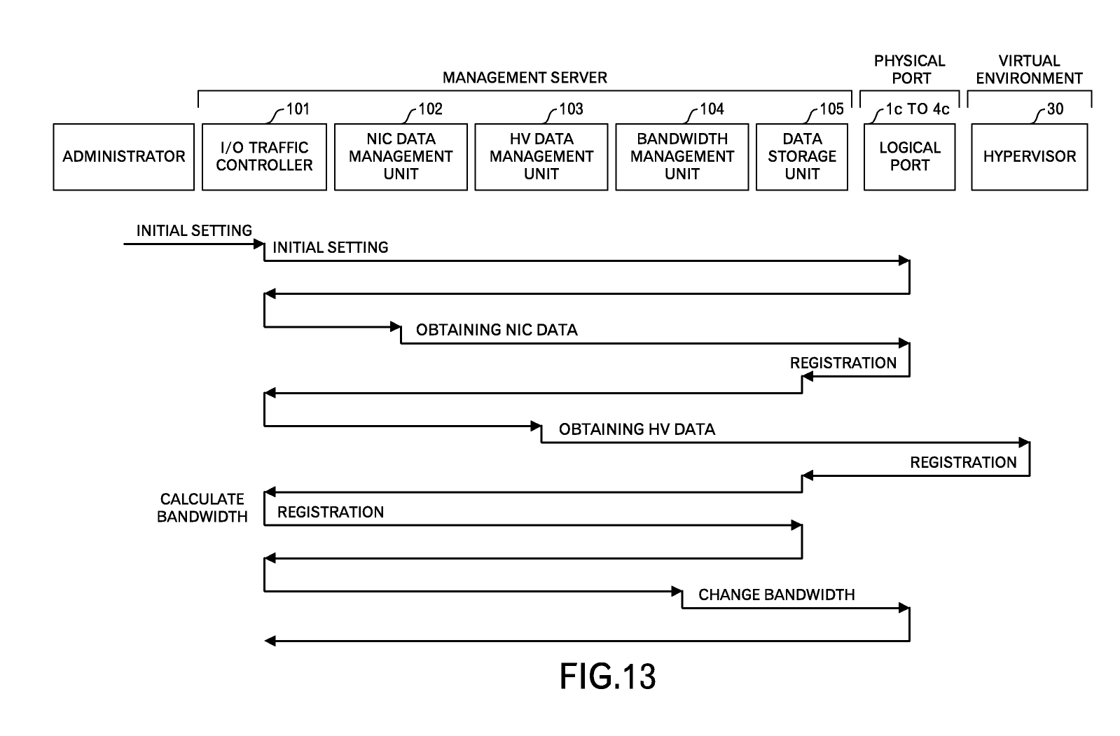

Next, sequential processing from the initial setting of the bandwidth to the change in the setting will be briefly explained using FIG. 13.

First, initial settings that were input by an administrator are applied to the logical ports 1c to 4c. In FIG. 13, the I/O traffic controller 101 performs initial setting of the logical ports 1c to 4c, however, it is also possible for the bandwidth management unit 104 to perform the initial setting.

After the initial setting is completed, the NIC data management unit 102 that received the acquisition instruction from the I/O traffic controller 101 obtains data from the physical port 1b, and together with registering the data in the data storage unit 105, outputs a notification of completion of registration to the I/O traffic controller 101.

Then, the HV data management unit 103 that received the acquisition instruction from the I/O traffic controller 101 obtains HV data from the hypervisor 30, and together with registering the data in the data storage unit 105, outputs a notification of completion of registration to the I/O traffic controller 101.

The I/O traffic controller 101 calculates bandwidth for each logical port based on the data that was stored in the data storage unit 105, and stores the calculation results in the data storage unit 105. Moreover, the I/O traffic controller 101 outputs a change instruction that includes the calculation results to the bandwidth management unit 104.

Accordingly, the bandwidth management unit 104 changes the bandwidth of each logical port, and outputs a notification of completion of change to the I/O traffic controller 101.

By executing processing such as described above, the bandwidth of the logical ports 1c to 4c are dynamically changed according to the actual operating states. And thus, together with being able to suppress an excess in bandwidth that was assigned to part of the logical ports, it is possible to suppress a bottleneck in part of the logical ports. In other words, it becomes possible to increase usability efficiency of the bandwidth of the physical port 1b.

Moreover, nodes such as servers, switches and the like are arranged in a data center on the scale of several thousands, and thus it is impossible to manually set the bandwidth for each logical port. However, by applying this embodiment, it becomes possible to automatically set the bandwidth for each logical port.

### Embodiment 2

FIG. 14 illustrates a configuration diagram of an operation server 3 in a second embodiment. As illustrated in FIG. 14, the operation server 3 has a physical NIC 1a. In the operation server 3, a hypervisor 30 and a management unit 31 that performs management of I/O traffic are executed. The management unit 31 is able to execute the same processing as the management server 1 in the first embodiment.

In this way, in this second embodiment, the management server 1 and operation server 3 are integrated. As a result, it is possible to conserve space.

Although the embodiments of this invention were explained above, this invention is not limited to those. For example, the functional block configuration of the management server 1 and operation server 3, which are explained above, does not always correspond to actual program module configuration.

Moreover, the aforementioned table configuration is a mere example, and maybe changed. Furthermore, as for the processing flow, as long as the processing results do not change, the turns of the steps may be exchanged or the steps may be executed in parallel.

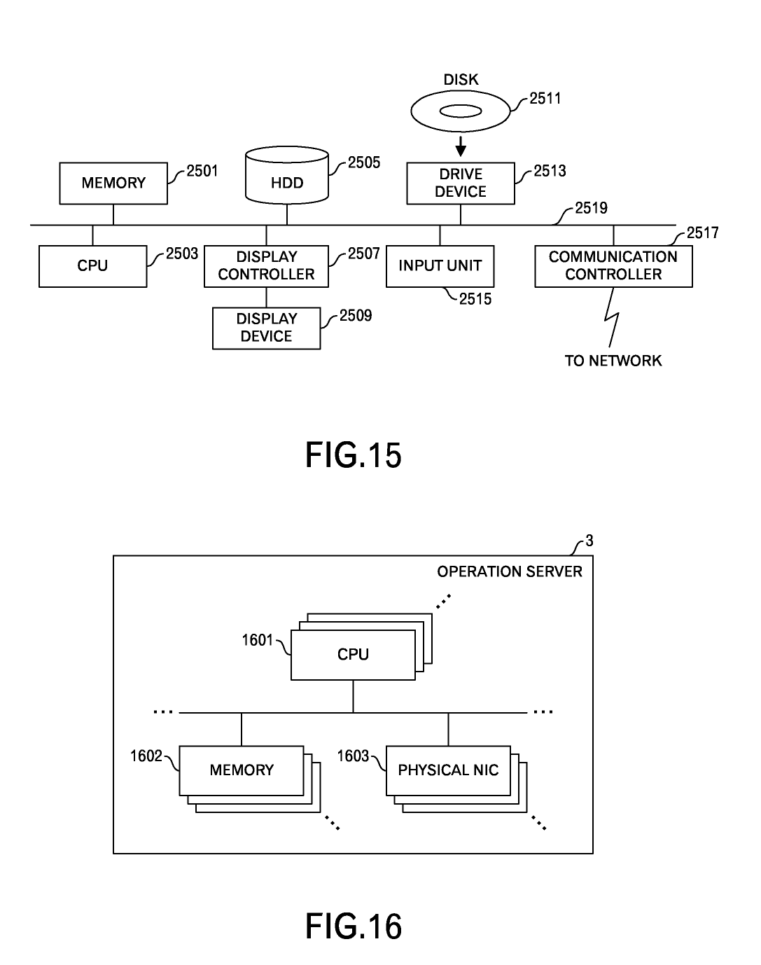

In addition, the aforementioned management server 1 is computer device as illustrated in FIG. 15. That is, a memory 2501 (storage device), a CPU 2503 (central processing unit) that is a hardware processor, a HDD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 15. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this technique, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer device as stated above, the hardware such as the CPU 2503 and the memory 2501, the OS and the application programs systematically cooperate with each other, so that various functions as described above in details are realized.

The operation server 3 described above has, as illustrated in FIG. 16, one or plural CPUs 1601, one or plural memories 1602, and one or plural physical NICs 1603. The program of the hypervisor 30 is loaded into a memory 1602 that will actually be executed, and is executed by a CPU 1601.

The aforementioned embodiments are summarized as follows:

An information processing apparatus relating to a first aspect of these embodiments include: a memory; and a processor coupled to the memory and configured to: (A) first calculate, for each of plural logical ports that are set for a physical network interface card, an amount of traffic of the logical ports, from amounts of output traffic of one or plural virtual machines that use the logical port; and (B) set, for each of the plural logical ports, bandwidth of the logical port according to the calculated amount of traffic of the logical port.

By performing such processing, appropriate bandwidth is set for each of plural logical ports, and it becomes possible to increase usability efficiency of bandwidth of the physical network interface card.

Moreover, the first calculating may include: (a1) obtaining an amount of output traffic of each virtual network interface card in the one or plural virtual machines from a virtual processing unit to realize the virtual machines; and (a2) second calculating the amounts of output traffic of the one or plural virtual machines, by summing the obtained amount of output traffic of each virtual network interface card. It becomes possible to accurately calculate an amount of traffic of a logical port, by utilizing amounts of output traffic of virtual network interface cards.

Moreover, the obtaining may include (a11) obtaining identification information of the one or plural virtual machines and identification information of virtual network interface cards included in each of the one or plural virtual machine.

Moreover, the first calculating may include: (a3) third calculating ratios of amounts of traffic of the plural logical ports; and (a4) fourth calculating bandwidth of each of the plural logical ports, by allocating bandwidth of the physical network interface card to each of the plural logical ports according to the calculated ratios. It becomes possible to set bandwidth according to an actual operating status.

A bandwidth setting method relating to a second aspect of these embodiments include: (C) calculating, for each of plural logical ports that are set for a physical network interface card, an amount of traffic of the logical ports, from amounts of output traffic of one or plural virtual machines that use the logical port; and (D) setting, for each of the plural logical ports, bandwidth of the logical port according to the calculated amount of traffic of the logical port.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
first calculate, for each of a plurality of logical ports that are set for a physical network interface card, an amount of traffic of the logical ports, from amounts of output traffic of one or a plurality of virtual machines that use the logical port; and
set, for each of the plurality of logical ports, bandwidth of the logical port according to the calculated amount of traffic of the logical port.

2. The information processing apparatus as set forth in claim 1, wherein the first calculating comprises:
obtaining an amount of output traffic of each virtual network interface card in the one or a plurality of virtual machines from a virtual processing unit to realize the virtual machines; and
second calculating the amounts of output traffic of the one or a plurality of virtual machines, by summing the obtained amount of output traffic of each virtual network interface card.

3. The information processing apparatus as set forth in claim 2, wherein the obtaining comprises obtaining identification information of the one or a plurality of virtual machines and identification information of virtual network interface cards included in each of the one or a plurality of the virtual machine.

4. The information processing apparatus as set forth in claim 1, wherein the first calculating comprises:
third calculating ratios of amounts of traffic of the plurality of logical ports; and
fourth calculating bandwidth of each of the plurality of logical ports, by allocating bandwidth of the physical network interface card to each of the plurality of logical ports according to the calculated ratios.

5. A non-transitory computer-readable storage medium storing a program for causing a computer to execute a process, the process comprising:
calculating, for each of a plurality of logical ports that are set for a physical network interface card, an amount of traffic of the logical ports, from amounts of output traffic of one or a plurality of virtual machines that use the logical port; and
setting, for each of the plurality of logical ports, bandwidth of the logical port according to the calculated amount of traffic of the logical port.

6. A bandwidth setting method comprising:
calculating, by using a computer and for each of a plurality of logical ports that are set for a physical network interface card, an amount of traffic of the logical ports, from amounts of output traffic of one or a plurality of virtual machines that use the logical port; and
setting, by using the computer and for each of the plurality of logical ports, bandwidth of the logical port according to the calculated amount of traffic of the logical port.
